(19) United States
(12) Patent Application Publication
(10) Pub. No.: US 2010/0251212 A1
(43) Pub. Date: Sep. 30, 2010

(54) Version Type Traversal

(75) Inventors: Brian M. Grunkemeyer, Redmond, WA (US); Madhusudhan Talluri, Bellevue, WA (US); Mauro M. Ottaviani, Bellevue, WA (US); Mei-Chin Tsai, Bellevue, WA (US); Brian K. Pepin, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/413,623

(22) Filed: Mar. 30, 2009

(51) Int. Cl. G06F 9/44; G06F 9/45

(52) U.S. Cl. 717/122; 717/140

(57) ABSTRACT

A version traversal system for objects, such as types, may include a reference to another version of an object with the type definition. The reference may be used to identify an older or newer version of the object which may be in a different assembly and may have a different simple name. The version traversal system may be used to compile applications written for the first version but compiled with assemblies from the second version, as well as serializing and deserializing objects from one version to another. The version traversal system may enable two way communications between applications that use two versions of a set of assemblies. The reference may include a fully qualified name or other identifiers.

### BACKGROUND

In computer programming, many languages allow the inclusion of code from libraries. A library may have many hundreds or types, classes, methods, and other objects, all of which may be called or referenced by an application.

Assemblies, the minimal deployable units of libraries, may grow and change over time. In many cases, an assembly may be published and applications may be written that use the assembly. When the assembly is updated, sometimes an object may be moved from one assembly to another.

When an application references a type within a assembly, and the type has been moved to a new assembly, a type forwarder may be placed in the new version of the original assembly that points a compiler to a new version of the type in a new assembly. Type forwarders are useful in any type of language, and have been deployed in runtime or just in time compiled environments.

In a just in time compiled environment, an application may be compiled against the current version of an assembly. Many assemblies are standardized code that may be updated from time to time. For example, an assembly may be updated to add a new feature, address a security breech, or for some other purpose which may cause a user to upgrade.

Type forwarding operates by placing a reference in a first assembly to a type definition in a second assembly. In the first assembly, the type is not defined. In place of the type is a reference to the type definition in the second assembly.

### SUMMARY

A version traversal system for objects, such as types, may include a reference to another version of an object with the type definition. The reference may be used to identify an older or newer version of the object which may be in a different assembly and may have a different simple name. The version traversal system typically supports running applications compiled for a first version on a second version. More challengingly, the version traversal system may be used to execute applications written for the first version but compiled with assemblies from the second version, as well as serializing and deserializing objects from one version to another. The version traversal system may enable two way communications between applications that use two versions of a set of assemblies. The reference may include a fully qualified name or other identifiers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for traversing between objects.

FIG. 2 is a flowchart illustration of an embodiment showing a method for updating assemblies and moving types between assemblies.

FIG. 3 is a flowchart illustration of an embodiment showing a method for switching versions in a compiled environment.

FIG. 4 is a diagram illustration of an embodiment showing a system for converting between versions.

FIG. 5 is a flowchart illustration of an embodiment showing a method for serializing and deserializing between versions.

### DETAILED DESCRIPTION

A version traversal system for objects may include one or more references along with an object definition when an object is moved from one assembly to another. The version traversal system may allow a compiler, serializer, or other process to traverse to another version of a library to find the other version of the object even if the object has been moved to a different assembly and, in some embodiments, a different framework of assemblies.

Assemblies may comprise one or more objects that are used in data structures, executable code, or other software constructs. The objects may be types, classes, methods, attributes, subroutines, procedures, functions, routines, or other objects. In some just-in-time compiler embodiments, assemblies may be compiled code in an intermediate language that may be further compiled at runtime. In some embodiments, an assembly may be referred to as a library, a Dynamic Linked Library (DLL), process assembly, plugin, shared object, or other names.

An object may have a reference associated with the object when the object is placed into a new assembly. The reference may refer to another version of the object in a different version of the same assembly or a different assembly, and may be used by a compiler, serializer, or other process to traverse different versions of assemblies to find the object associated with a selected version.

The reference may include a fully qualified name for the object. The fully qualified name may specifically and uniquely identify the object within a specific assembly for a specific version of the assembly.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, resources, data structures, etc. that perform particular tasks or implement particular abstract data types. Typically, the functionality of the program modules may be combined or distributed as desired in various embodiments.

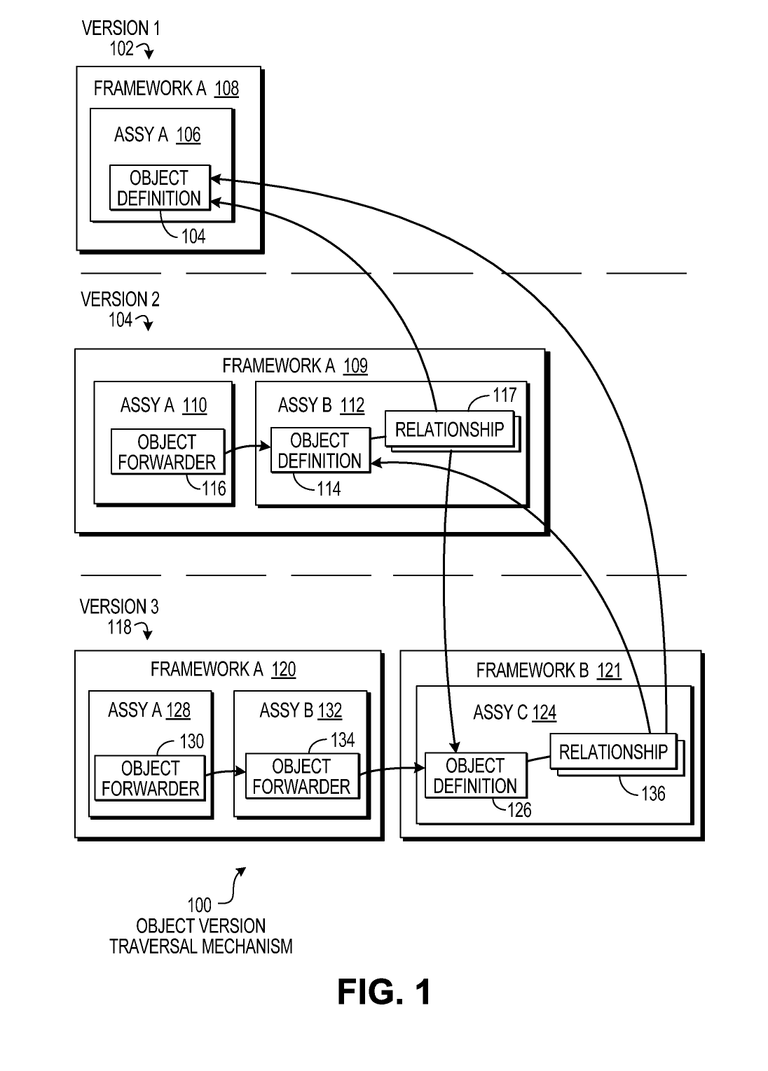

FIG. 1 is a diagram of an embodiment 100 showing a system that uses an object traversal mechanism. Embodiment 100 is a simplified example of a system that enables different versions of an object to be identified, given that the object may have been moved from one assembly to another in between versions.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of the components and relationships between objects in different versions of assemblies. In many cases, an assembly may have multiple objects. Over time, new assemblies may be created and some objects may be moved to the new assemblies. Objects may be moved in order to consolidate related objects together, to divide large assemblies into smaller ones, or for many other reasons. When an object is moved from one assembly to another, a relationship to the previous location may be included with the object definition.

The relationships may allow different versions of an object to be used in different circumstances. For example, compiled code may be written with one version of an object in mind, but may be compiled against another version. In another example, a serializer may serialize one version of an object and deserialize into a second version of the object.

In many embodiments, a set of assemblies may be distributed as different versions. The relationships defined in the assemblies may be used to traverse from one version to another to find a different version of an object. In some cases, different versions may be created over time, such as when a framework of assemblies is updated and improved. In other cases, different versions of assemblies may be created for different applications. For example, two versions of an assembly may be created for executing on two different hardware platforms or for two different types of end users. In some cases, two versions may be created and distributed as a full featured version and a lightweight version with fewer features.

The relationships may be traversed in several circumstances. In one example, an application may be written in code that refers to an object in one version of an assembly, but the application may be executed against a library that is of a different version. The relationship associated with the object in the original version may direct a compiler to the location of the object in the other version.

A relationship may be stored with an object definition. Such relationships may direct a compiler, deserializer, or other operation to jump from a current location to a location within another version of the same or a different assembly when the other version of the object is requested.

The relationship may refer to an object using a fully qualified name. Different embodiments may have different mechanisms for identifying another version of an object. A fully qualified name may include a reference to a namespace or context in which two objects may not share the same name. The namespace or context may include an identifier for the namespace as well as a specific version number of the namespace. In many embodiments, a namespace name and version identifier may uniquely identify an assembly. In other versions, multiple assemblies may be defined within the namespace, and a relationship may define the namespace, version of the namespace, and assembly name within the namespace.

In some embodiments, a relationship may refer to a namespace that is different from the namespace of the current version of an object. This may allow an object to be moved from one assembly in one namespace to another assembly in another namespace.

A fully qualified name may include a simple name that may be unique within the namespace. Some embodiments may use a unique name that may be used outside of a namespace.

Some relationships may include other parameters that may be used to identify an assembly. For example, some objects may be referred to using a namespace as well as an encryption key. The encryption key may be a public portion of a private key-public key encryption system. A compiler or other application that may use an object may be capable of decrypting an assembly or portion of an assembly using the public key. The public key may be a mechanism to verify authenticity of an assembly.

In some relationships, a parameter for a culture or language may be defined. The culture parameter may indicate which version of an assembly or object is being identified.

A unique identifier may be assigned to an object in one version and referenced in a relationship defined in another version. For example, a Globally Unique Identification (GUID) may be created for each object in an assembly. When an object is moved to another assembly, a relationship may be established to the first assembly and a GUID or other unique identifier may be used to specify the precise object within the assembly.

In some embodiments, an object within an assembly may have a different name in another assembly. The relationship associated with a current object may refer to an object with a different name in another assembly that may be used in place of the current object. Some embodiments may enforce a limitation of maintaining the same simple name between different versions of an object. Other embodiments may allow names to change between versions. One non-limiting example would be moving a type from one assembly to another in a new version of a set of libraries, while changing both the type's name and namespace.

The relationship may be considered to define an interoperable object for a current object. The interoperable object may be a different version of the current object or may be a completely different object that may be used in place of the current object. The different object may have similar input and output parameters or may function in a similar manner as a current object.

In some embodiments, the different version of the object may have input or output parameters that are different from a current version of the object. In an example scenario, a different version of a current object may have additional input parameters or other interface differences. The newer version of the object may be a superset of the previous version. A relationship defined for the current version of the object may include default values for the additional input parameters or other mechanisms to allow the second object to substitute for the first. In some embodiments, a mapping of parameter names or other information may be included in the relationship.

One implementation of a relationship may be a TypeForwardedFrom attribute. In a typical use scenario, the TypeForwardedFrom attribute may be included in a new location of an object and may refer to a previous version of an object when the object is moved from one assembly to another. The TypeForwardedFrom attribute may include the following parameters: an object name, an assembly name, a version number for the assembly, a culture indicator, and a public key. An example of a TypeForwardedFrom attribute is illustrated in the code snippet of Table 1. The example is one of many different implementations of a relationship that may be defined when an object is moved from one assembly to another. The example is not meant to reflect any specific implementation, but just as an example of how a relationship may be constructed.

TABLE 1
TypeForwardedFrom Example.

```
    // The TimeZoneInfo class was in Framework 3.5 in System.Core.dll
    // This was moved to mscorlib.dll in Framework 4.0 and
    renamed TimeZoneUtil
    [TypeForwardedFrom(“TimeZoneInfo, System.Core,
Version=3.5.0.0, Culture=Neutral, PublicKeyToken=b73d503eef394a9”)]
    public class TimeZoneUtil {
    ...
    }
```

The parameters of the TypeForwardedFrom example of Table 1 include “TimeZoneInfo”, which represents the name of the object in the other assembly. “System.Core” and “Version=3.5.0.0” represents the name and version number of the other assembly. The “Culture=Neutral” parameter may be a specific culture or language version of the other assembly. The “PublicKeyToken” parameter may be a public key that may be used to decrypt the assembly, the object, or some other parameter. The public key may be used to assure authenticity of the other assembly or object. The TypeForwardedFrom attribute may be stored with the definition of TimeZoneUtil within an assembly.

Embodiment 100 illustrates a series of versions of an object through several versions 102, 104, and 118. Embodiment 100 may be used to illustrate a timeline of an object that may occur over several iterations of the object.

In version 102, an object definition 104 is illustrated as being within Assembly A 106 inside Framework A 108. In version 104, the object definition 114 may be moved to Assembly B 112.

In version 104, the object definition 114 may be the same object definition as object definition 104, or the object definition 114 may be changed.

From version 102 to version 104, the object definition has been moved from Assembly A to Assembly B. Assembly A 110 may represent the second version of Assembly A, while Assembly A 106 may represent the first version of Assembly A. Assembly B 112 in version 104 may be a new assembly.

Assembly A in version 104 may include an object forwarder 116. The object forwarder 116 may define a relationship between the previous location of the object definition and the new location. In the case of object forwarder 116, a relationship between the first location of the object definition, Assembly A, and the second location, Assembly B, is established.

The object forwarder 116 may be used to indicate that the object definition 104 in the first version 102 of Assembly A 108 has moved to Assembly B 112 in the second version 104.

The object forwarder 116 may be used when code is written referring to the object definition 104 in Assembly A 106. When the code is compiled against version 102, the code may look up the object definition in Assembly A 110 and may find the object forwarder 116. The object forwarder 116 may direct the compiler to the object definition 114 in Assembly B 112.

The object definition 114 may have a relationship 117 that may be defined to point to the object definition 104 in Assembly A 106. Using a similar example as in the preceding paragraph, code that is written for the object definition 114 in Assembly B 112 may be redirected to the object definition 104 in Assembly A 106 if the version is rolled back from version 104 to version 102.

In version 118, the object definition 114 may be moved from Assembly B 112 to Assembly C 124. Also in version 118, the object definition 114 may be moved from Framework A 109 to Framework B 121.

In version 102, Assembly A 106 is located in Framework A 108. In version 104, the Framework A 109 may have grown to include Assembly B 112. In version 118, Framework B 121 may be added.

A framework may be a set or grouping of assemblies. In many cases, a framework may be a large package of objects such as types, classes, methods, and other elements that may be common to a large number of applications. Many frameworks may contain several assemblies. In many embodiments, a framework may have a namespace that defines unique names for objects within the namespace.

When the object definition 114 is moved from Assembly B 112 and Framework A 109 to Assembly C 124 in Framework B 121, an object forwarder 134 may be created in Assembly B 132. Inversion 118, the object forwarder 130 in Assembly A 128 may be the same object forwarder 116 in version 104. Object forwarder 130 may act as a pointer to Assembly B 132, where object forwarder 134 may act as a pointer to the object definition 126 in Assembly C. The object forwarder 134 may identify the object definition 126 in Framework B 121, which is outside Framework A 120.

The object forwarders 130 and 134 may be present so that when the object definition is searched for in either Assembly A 128 or Assembly B 132, an object forwarder may be present to point to the object definition 126. In the case of searching in Assembly A 128 for the object definition, the object forwarder 130 may point to object forwarder 134, which may point to the object definition 126. In such a case, two jumps may be performed to reach the object definition 126.

In some embodiments, the object forwarder 130 may be updated to point directly to the object definition 126 in Assembly C. In such an embodiment, a search of Assembly A 128 may result in a single, direct jump to the object definition 126.

The object definition 126 may include one or more relationships 136 that may point to other versions of the object definition. One relationship 136 may point to object definition 114 in Assembly B 112 in version 104, and another relationship 136 may point to the object definition 104 in Assembly A 106 in version 102. Such relationships may be considered to be backwards pointing, in that the relationships point to older versions of an object.

Similarly, when the object definition 114 is moved from Assembly B 112 to Assembly C 124, a relationship 117 may be added to point to the object definition 126 in Assembly C 124. Such a relationship may be considered to be forward pointing in that the relationship may point to a newer version of an object.

Embodiment 100 is an example of a migration of an object definition through two upgrades or version releases. Some embodiments may have fewer or more object forwarders and relationships defined.

Some embodiments may include relationships that refer to any version of an assembly, such as older or newer versions in a sequential version system. In cases where two or more versions of assemblies are created or used in parallel, the relationships may refer to the parallel versions.

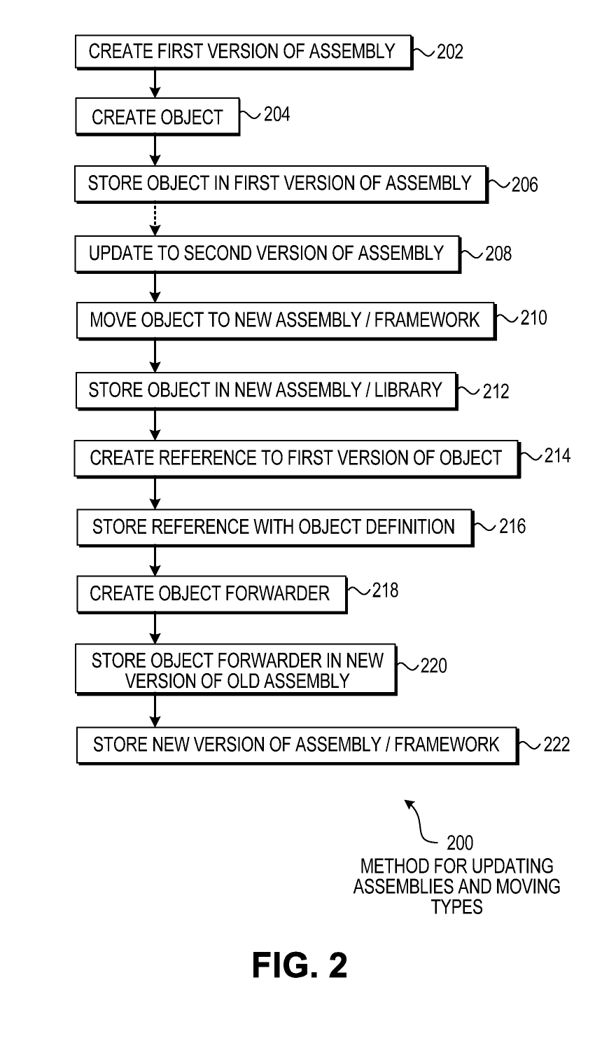

FIG. 2 is a flowchart illustration of an embodiment 200 showing a method for moving objects and updating assemblies. Embodiment 200 is an example of a method that may be used when moving an object from one assembly to another.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a typical scenario where an object is created and placed in an assembly, then moved to another assembly. When the object is moved, a relationship may be created pointing to the old version of the object, and an object forwarder may be placed in the new version of the original assembly.

In block 202, the first version of an assembly may be created. The object may be created in block 204 and stored in the first version of the assembly in block 206. In many cases, the first version of the assembly may be published and used after block 206.

In block 208, a second version of the assembly may be created and the object may be moved to a new assembly and, in some cases, a new framework in block 210. The object may be stored in the new assembly and new framework in block 212.

In some cases, the object may be updated or changed. In other cases, the object may be moved without changing the object.

In block 214, a reference to the first version of the object may be created. The reference may be stored with the object definition in block 216.

In block 218, an object forwarder may be created and, in block 220, the object forwarder may be stored in the new version of the old assembly. The object forwarder may act as a pointer to the object within that version of the assembly.

Once the object forwarder and relationships are defined and stored, the new version of the assembly and framework may be stored in block 222.

In embodiment 200, references are made to a first or second version of an assembly. The terms ‘first’ and ‘second’ may be used merely as identifiers and may not imply a sequence relationship between two versions. In some cases, a ‘second’ version may be produced before, during, or after production of a ‘first’ version.

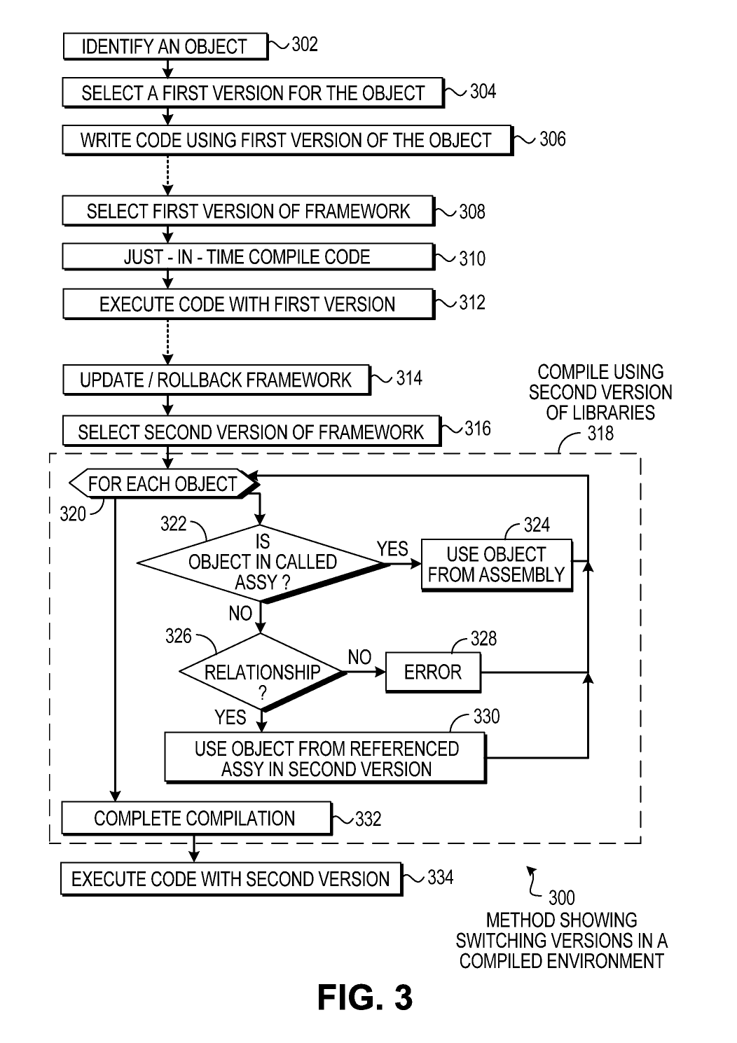

FIG. 3 is a flowchart illustration of an embodiment 300 showing a method showing switching versions of assemblies in a compiled environment. Embodiment 300 is an example of the operations that may be performed by a compiler when compiling code created for a first version with a framework or assemblies from another version. Embodiment 300 is an example that may be used in a compiled environment, running an intermediate language or byte code. In such an environment, source code may be compiled into the intermediate language prior to execution, then a just in time compiler may compile the intermediate language to assembly or other processor specific language at runtime.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 302, an object is identified, and the first version of the object may be selected in block 304. Code may be written using the first version of the object in block 306.

The operations of blocks 302 through 306 may be during the code development phase.

In block 308, the first version of the framework may be selected and the code may be compiled in block 310. The code may be compiled using a compiler and may be executed in block 312.

A runtime environment may compile code on demand or at runtime and may link various objects together at runtime to create executable code for a processor. In many cases, a just in time compiler may operate using code that is compiled into an intermediate code. The intermediate code may be partially optimized and may be linked to a framework at runtime. A class loader may be the portion of the runtime environment that uses the relationships to locate and load the appropriate objects from assemblies. The object forwarders and relationships illustrated and described in embodiments 100 and 200 may be used to allow different versions of a framework to be used with compiled code. The process of compiling and executing in blocks 310 and 312 may involve loading objects using a class loader, performing a just in time compilation of those objects into executable code, and executing the code on a processor.

In block 314, the framework version may be changed by upgrading or rolling back the framework version. The second version of the framework may be selected in block 316. In block 318, the second version of the framework may be used to compile the code created for a first version of the framework.

In order to compile using the second version of the framework, the definition of the object may be located in the appropriate version of the framework. Each object may be processed in block 320.

For each object in block 320, if the object is in the assembly in which it is called in block 322, the object may be used from that assembly in block 324. In such a case, the object may be in the same assembly as in the other version of the framework.

If the object is not in the called assembly in block 322, and no relationship exists in block 326, the object may not be located and an error may be raised in block 328. In some embodiments, the error of block 328 may cause the compilation to stop.

If a relationship is present in block 326, the object from the referenced assembly in the second version of the framework may be used in block 330.

After finding the appropriate versions of the objects in blocks 320 through 330, the compilation may be completed in block 322.

After compiling in block 322, the code may be executed with the second version of the framework and assemblies in block 334.

The operations of embodiment 300 may be performed in a production environment where an application written for one version of a framework is executed using a different version of the framework.

In some embodiments, an integrated development environment may perform some or all of the method of embodiment 300 in order to test code developed with one version of a framework against another version of a framework.

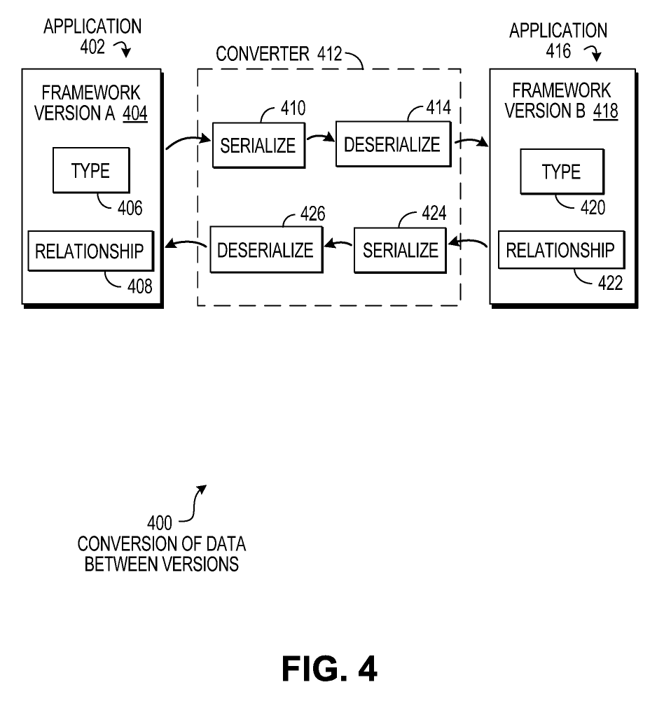

FIG. 4 is a diagram of an embodiment 400 showing a system that may use serialization and deserialization to convert from one framework version to another. Embodiment 400 may be used to translate between two different applications, or two versions of a single application: one running against a first version of a framework, the other running against a second version.

The diagram of FIG. 4 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 400 is an example of how serialization and deserialization may be used to bridge between applications that may be using different versions of a framework. The relationships that may be defined for objects that are moved between assemblies may be used to locate an object in another version of a framework.

In embodiment 400, application 402 may be created using framework version A 404. Within the framework, a type 406 and a relationship 408 are defined.

In the example of embodiment 400, a type 406 is used as an example of an object that may be defined with a relationship. The relationship 408 may point to a location of the type 406 in another version of the framework.

A converter 412 may have a serializer 410 and deserializer 414 that may be used to convert objects from the application 402 using framework version A 404 to the application 416 using framework version B 418. The converter 412 may serialize objects to convert using the serializer 410, and may deserialize the objects using the deserializer 414. The deserializer 414 may use the relationship 408 defined in framework version A 404 to locate a definition for the type 420 in framework version B 418. Note the serialized data may be sent between applications 402 and 416 over a network or persisted over a long period of time in a data file on disk.

The type 420 in framework version B 418 may be a different version of the type 406 in framework version A 404. The different versions of the types may be located in different assemblies in the framework. In other embodiments, the types may be located in different frameworks.

In some embodiments, type 406 and type 420 may have different names and may have different parameters or attributes.

The type 420 may include a relationship 422 that may refer back to the type 406 in framework version A 404. The converter 412 may have a serializer 424 and deserializer 426 that may be used to convert from framework version B 418 to framework version A 404. To facilitate lookups, the converter 412 when serializing at 410 or 424 may use the relationship 422 to persist a uniform way for another converter to find the type in framework version A 404, regardless of the location of the type in framework version B 418. For example, by choosing to describe the type using its original name in its original assembly, older versions of the framework can deserialize the type without needing to know about the layout of the new framework.

An example of the operations that may be performed by the converter 412 is illustrated in embodiment 500.

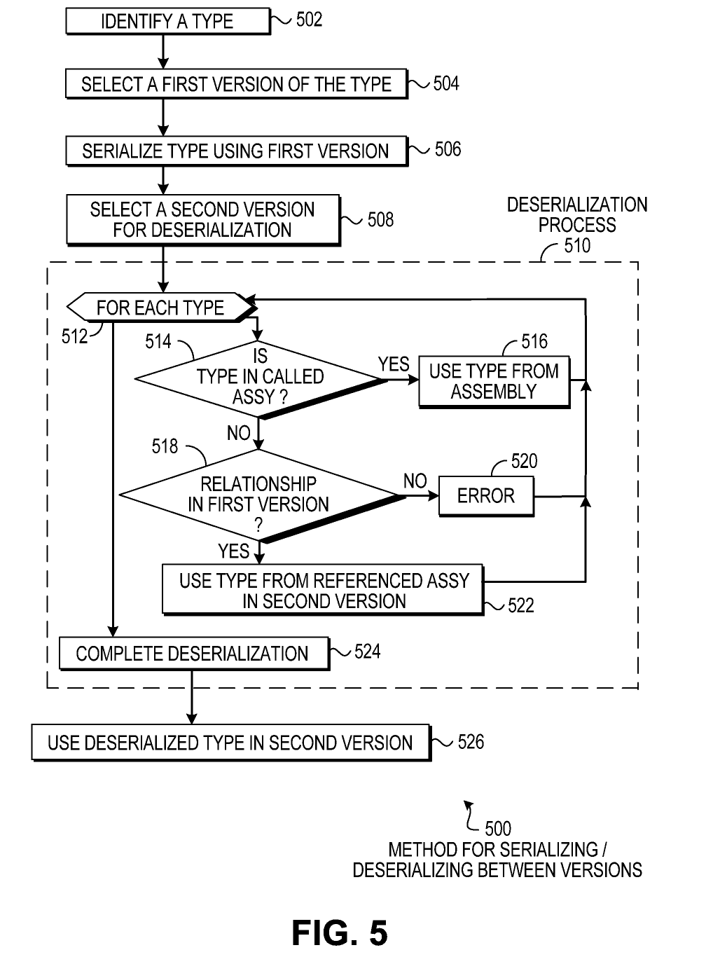

FIG. 5 is a flowchart illustration of an embodiment 500 showing a method of converting objects between versions by serializing and deserializing the objects. Embodiment 500 is an example of a process that may be performed by the converter 412 of embodiment 400.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is an example of a process that may be performed to convert from one version of an object to another using a serialization/deserialization process. During the deserialization process, a relationship may be used to locate an object if the object has moved from one assembly to another. The relationship may be defined along with an object in a first version of an assembly and may point to a second version of the object in another assembly. In some cases, the second version of the object may be in another framework or group of assemblies.

In block 502, a type may be identified. Embodiment 500 may use a type as an example of an object that may be processed using the serialization/deserialization method of embodiment 500. Other embodiments may process other objects in a similar manner.

The first version of the type may be selected in block 504 and the type may be serialized in block 506 using the first version of the type.

In block 508, as second version may be selected for deserialization. The second version may be any other version of the type. In some cases, the second version may be an earlier version or later version in the case of a sequential set of versions.

In other cases, a second version may be a different configuration of the first version, where the first and second versions may both be ‘current’ versions but configured for different purposes. For example, a first version may be a simplified version and the second version may be an expanded version. In another example, the first version may be tailored to a specific location, culture, or country and the second version may be tailored to a different location, culture, or country. Alternately, one version may be a subset of another, such as a slimmed-down release for client machines or a smaller release for less capable devices such as cell phones.

In block 510, a deserialization process may occur.

In the deserialization process of block 510, each type may be analyzed in block 512. If the type is in the second version of the called assembly in block 514, the type may be used from that assembly in block 516. In such a case, the type may not have been moved from one assembly to another.

If the type or other object has been moved, the type would not be in the called assembly in block 518. If there is no relationship defined in the first version of the type in block 518, an error may be thrown in block 520. In some embodiments, the error in block 520 may be resolved by searching the second version of the assemblies for the type or some other automated mechanism. In some cases, the error in block 520 may cause the translation process of embodiment 500 to be halted.

If the type has been moved in block 514 and a relationship is defined in block 518, the type from the referenced assembly in the second version may be used in block 522.

The processing of each type in block 512 may be performed to match the first version of a type to a second version of the type. Once all the types are matched, the remainder of the deserialization process may be performed in block 524, and the deserialized type may be used in the second version in block 526.

The methods of embodiments 300 and 500 illustrate two different uses for relationships. In embodiment 300, relationships are used at compile time to use a different version of an assembly from the version with which an application was originally designed. In embodiment 500, a serialization and deserialization routine may be used to interchange objects from one version to another. Other embodiments may include using relationships to traverse through several versions of a framework using static analysis tools. Such tools may be used in version management of assemblies and frameworks and may track version histories of objects within the frameworks.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
identifying a first version of a framework comprising a first object and a reference to said first object, said reference being to a second version of said first object in a second version of said framework;
determining that said second version of said framework is to be used for said first object; and
using said reference within said first version of said framework to identify a second version of said first object in said second version of said framework.

2. The method of claim 1, said first version of said first object being in a first assembly within said first version of said framework and said second version of said first object being in a second assembly within second version of said framework.

3. The method of claim 2, said second version of said framework not containing said first assembly.

4. The method of claim 1, said first version being a newer version than said second version.

5. The method of claim 1, said second version being a newer version than said first version.

6. The method of claim 1, said method being performed while compiling a first program comprising a call to said first object.

7. The method of claim 6, said call referencing said first object in said first version of said framework.

8. The method of claim 6, said compiling being performed during design time and in a development environment.

9. The method of claim 6, said compiling being performed in a just in time compilation operation.

10. The method of claim 1, said first version of said first object having a first name, and said second version of said first object having a second name.

11. The method of claim 10, said reference comprising a unique identifier for said first object.

12. The method of claim 11, said unique identifier being a GUID.

13. The method of claim 1, said method being performed during serialization.

14. A compiler configured to perform a method comprising:
receiving a program to compile, said program comprising a call to a first type, said first type being defined in a first version of a first assembly, said first assembly being part of a framework, each of said assemblies in said framework having said first version;
determining that a second version of said framework is to be used for compiling said program;
using a reference defined in said first version of said first assembly to determine that said first type is located in a second assembly within said second version of said framework; and
using said first type as defined in said second assembly to compile said program.

15. The compiler of claim 14 being a just in time compiler.

16. The compiler of claim 14, said first version of said first type having a first simple name, and said second version of said first type having a second simple name.

17. A computer readable storage medium comprising computer executable instructions for performing a method comprising:
identifying a first version of a framework comprising:
a first type having a first name, said first type being in a first assembly within said framework;
a reference to said first type, said reference being to a second version of said first type in a second version of said framework, said second version being an earlier version than said first version, said
reference comprising a second name for said first type, said
reference being within said first assembly;
determining that said second version of said framework is to be used for said first type; and
using said reference within said first version of said framework to identify a second version of said first type in said second version of said framework.

18. The medium of claim 17, said first assembly not being present in said second version of said framework.

19. The medium of claim 18, said reference comprising a fully qualified name for said first type within said second version.

20. The medium of claim 19, said reference further comprising a GUID.
